(19) United States
(12) Patent Application Publication
(10) Pub. No.: US 2024/0238156 A1
(43) Pub. Date: Jul. 18, 2024

(54) SEXUAL AID APPARATUS CAPABLE OF PROVIDING A CHILLING OR HEATING SENSATION

(71) Applicant: Courtney Padjen, Minneapolis, MN (US)

(72) Inventor: Courtney Padjen, Minneapolis, MN (US)

(21) Appl. No.: 18/155,203

(22) Filed: Jan. 17, 2023

(51) Int. Cl. A61H 19/00

(52) U.S. Cl. CPC A61H 19/44; A61H 2201/0107; A61H 2201/0207; A61H 2201/0214

(57) ABSTRACT

This disclosure provides a novel sexual aid apparatus having a housing compartment configured to contain a temperature filler that provides a chilling or heating sensation during use.

### FIELD OF THE INVENTION

This invention relates generally to a medical and sexual aid apparatus having a housing compartment configured to receive and/or contain a temperature filler that provides a chilling or heating sensation to a user during use.

### BACKGROUND

As gender reassignment becomes more readily available, more and more individuals who were born male but identify as female are able to undergo surgery to achieve anatomy that matches their identity. Dilator devices for aiding in the recovery and necessary dilation for post-operative transgender females exists. However, these devices are often the same as or substantially similar to sexual aids or toys currently for sale. Further, the devices fail to provide medicinal relief to address the inflammation, swelling, soreness, and other symptoms experienced.

Further, devices for aiding in the pleasure of sexual experiences have been in existence for many years. Among devices commercially available for enhancing sexual experiences are dildos, vaginal exercise bars, and prostate stimulators. Devices, such as dildos, are typically a penis-shaped member than can be inserted into the vagina and anus. Different shapes and sizes of dildos are available in the market. Some existing dildos have the ability to vibrate and include a vibrating means to increase sexual pleasure and to provide additional sensation for a user. Although these devices provide pleasure for their users, there is a deficiency in providing a safe chilling or heating sensation to the user during use. Further, many devices that do offer such a sensation offer only one sensation or the other.

Therefore it is desirable to provide a medical and/or sexual aid apparatus which obviates the foregoing and other limitations and disadvantages of the prior art devices, at least by providing a safe chilling and/or heating option for the user.

### SUMMARY

This disclosure addresses the need mentioned above in a number of aspects by providing a medical or sexual aid apparatus (herein “sexual aid apparatus”) having a housing compartment configured to contain a temperature filler that provides a safe chilling or heating sensation to a user during use.

In some embodiments, the sexual aid apparatus comprises a hollow, longitudinal shaft having a head portion located at the distal end of the shaft, an end portion located at the proximal end of the shaft, a housing compartment configured to contain a temperature filler that provides a chilling or heating effect during use, and wherein the end portion comprises an opening configured to receive the temperature filler and a cap member configured to seal the opening after the temperature filler is loaded in the housing compartment of the shaft.

In some embodiments, the cap member seals the opening through a snap-and-fit mechanism or a screwing mechanism.

In some embodiments, the sexual aid apparatus further comprises a holder portion attached to the end portion, which is designed to assist in the placement, removal and/or use of the device. In some embodiments, the holder comprises a suction cap. In some embodiments, the holder is substantially ring-shaped having an aperture that allows one or more fingers to insert therethrough.

In some embodiments, the sexual aid apparatus further comprises a rabbit affixably attached to the outer surface of the end portion.

In some embodiments, the sexual aid apparatus further comprises a vibrating device located at the head portion or at the shaft, wherein the vibrating device causes at least the head portion vibrates during use.

In some embodiments, the sexual aid apparatus further comprises the temperature filler contained in the housing compartment of the shaft. In some embodiments, the temperature filler is a cool filling. For example, in some embodiments, a freeze gel may be used, which comprises any one of a gelatin gel, an agar hydrogel, a polyvinyl alcohol gel, a carboxymethyl cellulose gel, or combinations thereof. In some embodiments, the temperature filler comprises a medical-grade ice pack. Any suitable cool filling may be used. Additionally or alternatively, the temperature filler may be a warm filling. In still other embodiments, a cooling, warming, or prolonging gel or topical agent may be used on an exterior surface of the sexual aid apparatus. For example, in some embodiments, a warming gel, such as but not limited to KY warming gel may be used. Additionally or alternatively, a prolonging agent may be used. Any suitable cooling or warming temperature filler or topical agent may be used.

In some embodiments, the housing compartment has a cross-section having a circular, elliptical, square, rectangular, polygonal, quadrilateral, square, triangular, parallelogram, pentagonal, hexagonal, heptagonal, or octagonal shape. As will be appreciated, the housing compartment may have any suitable cross-sectional shape or dimensions.

In a preferred embodiment, the shaft has a substantially cylindrical shape. In other embodiments, the shaft may be any suitable shape. In some embodiments, the shaft may include one or more additional features, including but not limited to a plurality of bumps, a plurality of ridges, one or more rings, any other other suitable feature, and/or or a combination thereof. In some embodiments, the shaft and the head portion are fabricated as one piece. In other embodiments, the shaft and head portion may be fabricated as two or more pieces.

In some embodiments, the head portion is substantially dome-shaped or shaped to mimic the penis of the human male. In some embodiments, the head portion includes one or more features, including but not limited to dimples or ribbed indentations located on the surface of the head portion. As will be appreciated, embodiments of the present invention may assume the shape of any existing vibrator or dildo. As may be further appreciated, any suitable shape or feature may be used.

In some embodiments, the sexual aid apparatus is configured for insertion into a bodily orifice (e.g., anus, vagina). In some embodiments, the sexual aid apparatus has a phallic shape imitative of a human penis, finger, or hand. However, other natural or artificial shapes can also be mimicked.

In some embodiments, the shaft, the head portion, the holder, and/or the end member is formed of inert and hypoallergenic material. In some embodiments, the shaft, the head portion, the holder, and/or the end member is comprised or one or more materials, including without limitation, latex rubber, silicone, acrylic, glass, cyberskin, vinyl, wood, metal, plastic, any other suitable material, or any combinations thereof. In at least some embodiments, the shaft, the head portion, the holder, and the end member are formed of different materials.

Also within the scope of this disclosure is a kit comprising a sexual aid apparatus described above.

In another aspect, this disclosure further provides a method of providing a chilling or heating sensation in a bodily orifice (e.g., anus, vagina) of a user. The method comprises loading a temperature filler capable of providing a chilling or heating effect during use; and inserting the sexual aid apparatus as described into the bodily orifice of the user.

The foregoing summary is not intended to define every aspect of the disclosure, and additional aspects are described in other sections, such as the following detailed description. The entire document is intended to be related as a unified disclosure, and it should be understood that all combinations of features described herein are contemplated, even if the combination of features are not found together in the same sentence, or paragraph, or section of this document. Other features and advantages of the invention will become apparent from the following detailed description. It should be understood, however, that the detailed description and the specific examples, while indicating specific embodiments of the disclosure, are given by way of illustration only, because various changes and modifications within the spirit and scope of the disclosure will become apparent to those skilled in the art from this detailed description.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures.

FIG. 1a depicts a sexual aid apparatus, in accordance with one embodiment of the present invention.

FIG. 1b depicts a sexual aid apparatus, in accordance with one embodiment of the present invention.

FIG. 2a depicts an end portion of a sexual aid apparatus, in accordance with one embodiment of the present invention.

FIG. 2b depicts an end portion of a sexual aid apparatus, in accordance with one embodiment of the present invention.

FIG. 3 depicts a sexual aid apparatus, in accordance with one embodiment of the present invention.

FIG. 4 depicts a sexual aid apparatus, in accordance with one embodiment of the present invention.

FIG. 5 depicts a sexual aid apparatus, in accordance with one embodiment of the present invention.

FIG. 6 depicts a sexual aid apparatus, in accordance with one embodiment of the present invention.

FIG. 7 depicts a sexual aid apparatus, in accordance with one embodiment of the present invention.

FIG. 8 depicts a sexual aid apparatus, in accordance with one embodiment of the present invention.

FIG. 9 depicts a sexual aid apparatus, in accordance with one embodiment of the present invention.

FIG. 10 depicts a sexual aid apparatus, in accordance with one embodiment of the present invention.

FIG. 11 depicts a sexual aid apparatus, in accordance with one embodiment of the present invention.

FIG. 12 depicts a sexual aid apparatus, in accordance with one embodiment of the present invention.

FIG. 13 depicts a sexual aid apparatus, in accordance with one embodiment of the present invention.

FIG. 14 depicts a sexual aid apparatus, in accordance with one embodiment of the present invention.

FIG. 15 depicts a sexual aid apparatus, in accordance with one embodiment of the present invention.

FIG. 16 depicts a sexual aid apparatus, in accordance with one embodiment of the present invention.

FIG. 17 depicts a sexual aid apparatus, in accordance with one embodiment of the present invention.

### DETAILED DESCRIPTION

This disclosure provides a novel medical or sexual aid apparatus having a housing compartment configured to contain a temperature filler that provides a chilling or heating sensation to a user during use. The device can be used in a variety of ways, including but not limited to as a dildo, a vaginal exercise bar, a dilator, and/or a prostate stimulator.

In one aspect, this disclosure provides a sexual aid apparatus comprising: (i) a hollow, longitudinal shaft including a housing compartment contained therein, which is configured to receive and contain a temperature filler; (ii) a head portion located at the distal end of the shaft; and (iii) an end portion located at the proximal end of the shaft, wherein the end portion comprises an opening configured to receive the temperature filler and a cap member configured to seal the opening after the temperature filler is loaded in the housing compartment of the shaft.

The sexual aid apparatus, as described herein, is configured to assist in the dilation of a vagina or anus. For instance, the device may be used to assist in the necessary dilation of a vagina after a gender reassignment surgery. The device may similarly be used to assist in the dilation of a vagina or anus where, for example, a stretching or dilation thereof is desired.

The sexual aid apparatus may, additionally or alternatively, be configured to provide relief from inflammation, soreness, or other symptoms, and/or provide a pleasurable and/or soothing touch during use. In particular, the cooling or heating sensation may be used either erotically to arouse the person on whom it is used or therapeutically to sooth sore tissues, particularly tissues within bodily orifices (e.g., vagina, anus). The heating functionality may also be used to adapt the sexual aid apparatus to human body temperature.

In some embodiments, the desired operating temperature of the sexual aid apparatus may vary from one individual to another. In the chilling mode, it is desirable to maintain the sexual aid apparatus at a temperature less than room temperature (approximately 35-65° F.). In a preferred embodiment, the chilling mode may be approximately 35-45° F. However, any suitable temperature may be used. In the heating mode, it is desirable to maintain the sexual aid apparatus at a temperature greater than room temperature (approximately 75-98° F.). In a preferred embodiment, the heating mode may be between approximately 85-95° F. However, any suitable temperature may be used. It is desirable in both erotic and therapeutic uses for the cooling properties of the sexual aid apparatus to be able to maintain at a relatively constant temperature, i.e., near, or at least slowly changing from near, the desired operating temperature over an extended period of time. In other embodiments, it may be desirable for the temperature to return to room or body temperature after a short period of time. As will be appreciated by those skilled in the art, different materials may transfer or retain the temperature from the gel pack or filler with varying efficiencies and to varying degrees. For instance, some materials may be more conducive to temperature transfer than other synthetic or insulating materials. In one embodiment, the apparatus may be comprised of stainless steel. In such an embodiment, it may be desirable for the temperature filler to be a more moderate temperature to prevent the exterior surface from becoming too cold or too hot. In another embodiment, the apparatus may be comprised of a synthetic material, e.g. silicon, which may be able to withstand higher or lower temperatures because the synthetic material may act as an insulator. In at least one embodiment, more than one material may be used.

The sexual aid apparatus described herein can be used by individuals of either sex, by transgender (post gender-confirmation surgery) persons, and by couples (heterosexual, homosexual, etc.) to provide sexual pleasure, either in lieu of or in addition to vaginal/penile or other modes of sexual congress. In addition to their use for pleasure, the use of the disclosed sexual aid apparatus may be recommended by physicians and other health professionals for the purpose of developing, strengthening, tightening, or otherwise enhancing the function of muscles, glands, and other organs surrounding the vagina and/or urethra and/or anus. Conditions in which such use may be recommended include post sex reassignment surgery, post-partum vaginal recovery, prostatitis, multiple sclerosis, anorgasmia, and urinary incontinence. The use of the sexual aid apparatus may also be recommended for purposes such as contraception, avoidance of disease (including AIDS), disability, erectile dysfunction, and temporary fatigue.

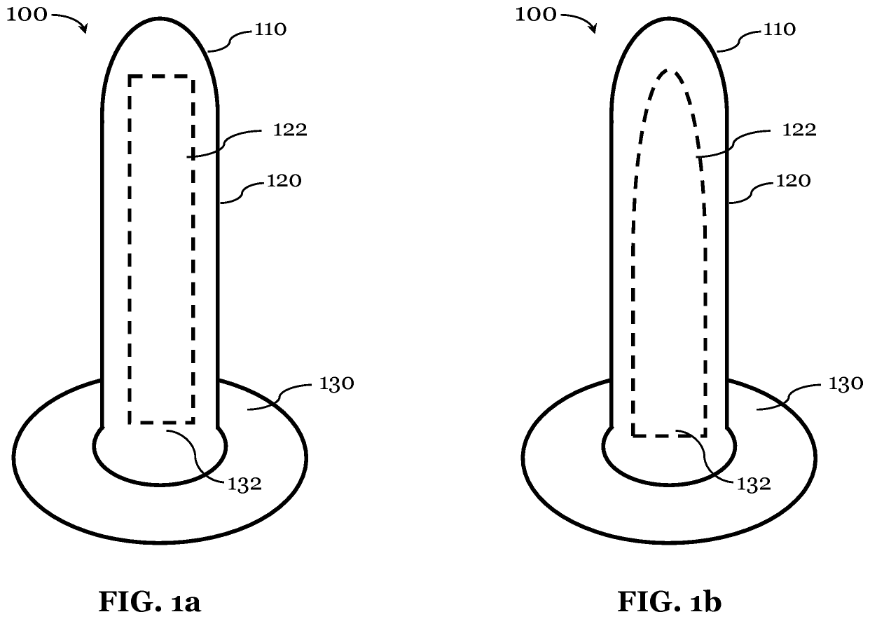

Referring to FIGS. 1a-b, sexual aid apparatus 100 may, in some embodiments, include a head portion 110, an end portion 130, and longitudinal shaft 120 comprised therebetween. In other embodiments, the sexual aid apparatus 100 may not include one or more of these parts. In a preferred embodiment, the shaft 120 is hollow and includes housing compartment 122. In some embodiments, the head portion and/or end portion may, additionally or alternatively, be hollow and contain a portion of the housing compartment 122 and/or an additional housing compartment. In several embodiments, the apparatus 100 further includes an opening 132 into the hollow housing compartment 122. In some embodiments, the apparatus 100 further includes a cap member 134 to close or cover opening 132.

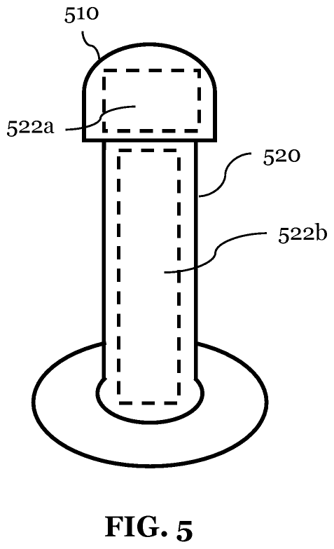

The head portion 110 is configured to insert into the vaginal or anal cavity of the user. The head portion 110 may be tapered, as shown in FIGS. 1a-b, in order to assist in the assertion of the apparatus 100 into the vaginal or anal cavity. In some embodiments, the head portion 110 may, additionally or alternatively, be alternatively shaped to provide a different sensation to the user. For example, as seen in FIGS. 5-17, the head portion may be comprised of one or more of any number of shapes including bulbous, fingered, amorphous, etc.

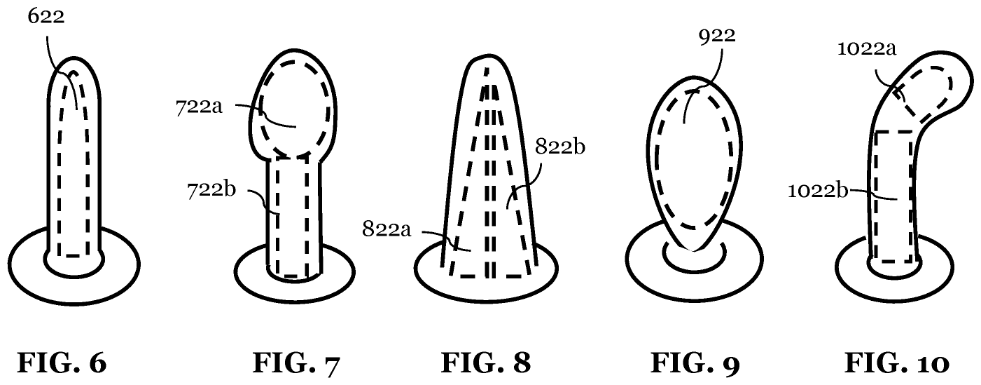

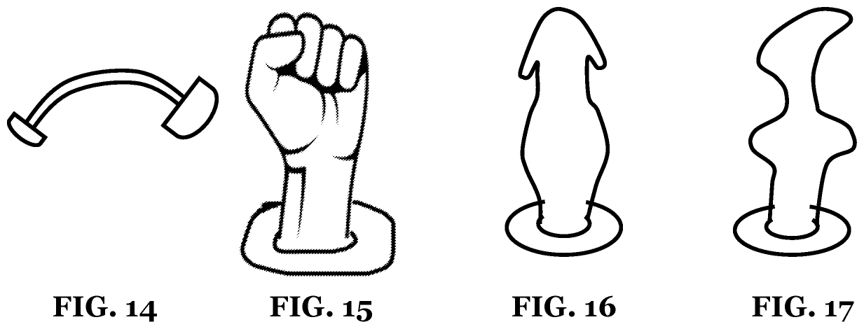

The shaft 120 is configured to insert, partially or wholly, into the vaginal or anal cavity of the user. In some embodiments, as seen in FIGS. 1a-b, the shaft 120 may be substantially cylindrical. In other embodiments, any desired shape may be used. In some embodiments, as also seen in FIGS. 1a-b, the same diameter and/or circumference may be used for some or all of the length of the shaft 120. In some embodiments, as seen for example in FIGS. 6 and 8, the shaft may be greater in diameter near the head portion and lesser in diameter near end portion. In other embodiments, as seen for example in FIG. 9, the shaft may be smaller in diameter than head portion. In still other embodiments, as seen for example in FIG. 7, the diameter of the shaft may increase from head portion to end portion. As will be appreciated, any suitable size, shape, or dimensions of the shaft may be used. In addition, as seen in FIGS. 1a-b, the shaft 120 may, in some embodiments, be substantially straight. In other embodiments, as seen in FIG. 10 or 14, the shaft may be curved or bent.

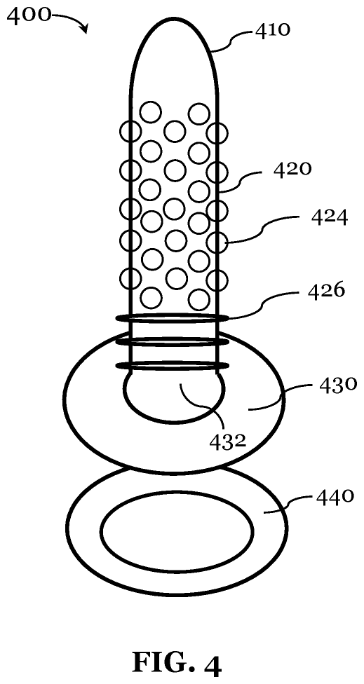

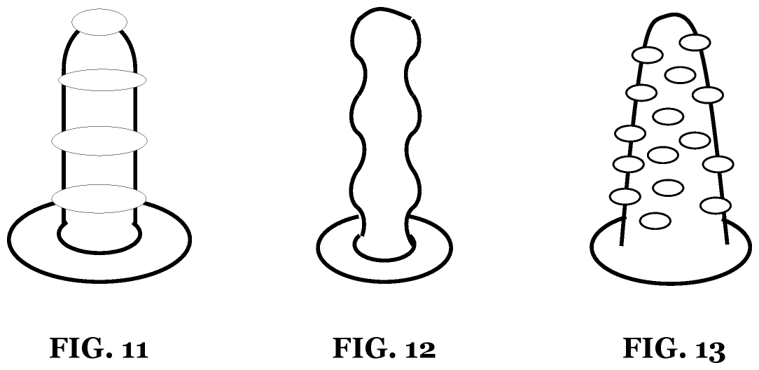

In some embodiments, the shaft 120 or the head portion 110 may have various surface textures. For example, the shaft 120 or the head portion 110 may include a plurality of bumps, a plurality of ridges or a combination thereof. In some embodiments, the head portion 110 may be substantially dome-shaped or shaped to mimic the penis of the human male. In some embodiments, the head portion 110 comprises dimples or ribbed indentations located on the surface of the head portion 110. For example, as seen in FIG. 4, the shaft may include one or more ribs 424 or rings 426. In some embodiments, the ribs 424 and/or rings 426 may be raised, i.e., extending outwardly from the surface of the shaft 420. In other embodiments, one or more of the ribs 424 and/or rings 426 may be indented. As shown in FIGS. 11-17 and as will be appreciated by those skilled in the art, any number of suitable raised or indented structures may be included on the apparatuses of the present invention.

The end portion 130, located opposite the head portion 110 on shaft 120, may prevent over insertion into the vaginal or anal cavity of the user. Accordingly, in some embodiments, the end portion 130 may be larger in diameter than shaft 120. In some embodiments, as shown in FIGS. 1a-1b, the end portion 130 may extend beyond the diameter of the shaft 120 in all directions, or in 360 degrees. In at least some embodiments, the end portion may only extend beyond the diameter of the shaft in one or two directions. Further, the end portion may curve to mimic the natural anatomy of the user. As will be appreciated, the end portion may have various sizes. Preferably and advantageously, the end portion has a size larger than the opening of a bodily orifice (e.g., vaginal opening) of a user.

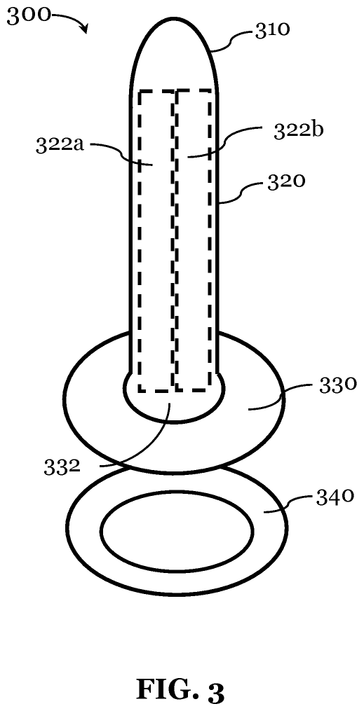

With reference to the apparatuses 300, 400 in FIGS. 3 and 4, a holder 340, 440 may also be included. In at least some embodiments, the holder 340, 440 attached to the end portion 330, 430. In some embodiments, the holder 340, 440 may include a handle or a suction cap. In some embodiments, the holder 340, 440 is substantially ring-shaped having an aperture that allows one or more fingers to insert therethrough. In some embodiments, the holder 340, 440 is formed integral the end portion 330, 430. In other embodiments, the holder 340, 440 is a separate component, which may be attached or detached to end portion 330, 430 and/or shaft 320, 420.

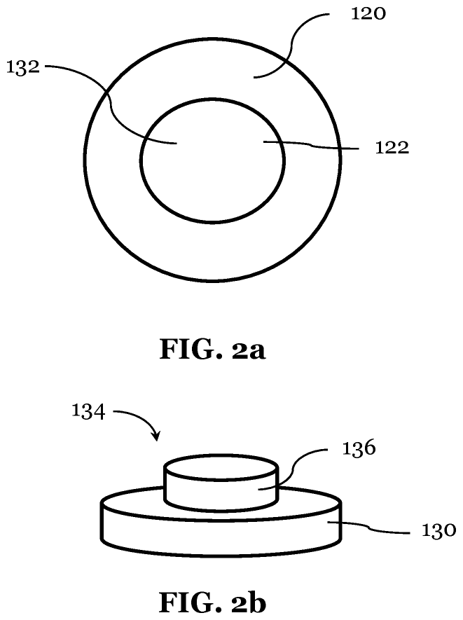

With reference back to FIGS. 1a-b, in most embodiments the shaft 120 may include an opening 132. With additional reference to FIGS. 2a-2b, the opening 132 into shaft 120, as well as the cap member 134 of end portion 130, according to one embodiment, are shown. The opening 132 may allow access to the hollow housing compartment 122. As shown, the opening 132 may be located at the end portion 130 side of shaft 120. A cap member 134 may be used to plug, close, or otherwise cover opening 132. In at least some embodiments, as shown in FIG. 2b, the cap member 134 may be integral to the end portion 130. In other embodiments, the cap member 134 may, additionally or alternatively, be a separate component. In some embodiments, the cap member 134 may include a plug 136 that is sized to securely squeeze or snap into the opening 132. In other embodiments, the plug 136 and opening 132 may be threaded such that the plug 136 of the cap member 134 may screw into opening 132. As will be appreciated, any suitable structure or arrangement to secure cap member 134 may be used.

In some embodiments, an opening 132 may, additionally or alternatively, be located in other locations. For example, and with reference to FIG. 9, the head portion 910 may be removable from shaft 920. For instance, the head portion 910 may be threaded onto shaft 920. Once the head portion 910 is removed, an opening into one or more hollow housing compartments 922a, 922b may be revealed. That is, there may be an opening in head portion 910 into housing compartment 922a and another opening in shaft 920 into housing compartment 922b. Any suitable location for the one or more openings may be used.

The housing compartment 122 is configured to contain a temperature filler (not shown). In some embodiments, and with reference back to FIGS. 1a-b, the housing compartment 122 may be located in the hollow shaft 120. In some embodiments, and with reference to FIG. 3, the shaft 320 may include more than one housing compartment 322a, 322b. In still other embodiments, and with reference to FIG. 5, the shaft 520 may contain a housing compartment 522b and the head portion 510 may contain another housing compartment 522a. Any suitable portion of the apparatus 100, 200, 300, 400 may be hollow and/or contain a housing compartment. As seen in FIGS. 5-10, the housing compartment(s) may be any suitable shape, including square, rectangle, circle, oval, triangle, cylindrical, oblong, any other suitable shape, or any combination thereof. In some embodiments, the horizontal cross-section of the housing compartment 122 may have various shapes. For example, the horizontal cross-section of the housing compartment 122 may have a circular, elliptical, square, rectangular, polygonal, quadrilateral, square, triangular, parallelogram, pentagonal, hexagonal, heptagonal, or octagonal shape. As may be appreciated, any suitable sized or shaped housing compartment may be included in any shaped apparatus, including one or more compartments designed to be incorporated into the apparatuses shown in FIGS. 11-17. Further, as seen in FIGS. 5-10, one or more housing compartments may be included in each apparatus.

Each housing compartment is configured to receive one or more temperature fillers. The temperature filler(s) may be loaded into the housing compartment using the one or more openings 132, discussed above. Each temperature filler may be configured to provide a chilling or heating effect during use. In some embodiments, the temperature fillers may be sized and shaped substantially similar to the housing compartments they are to be received into, such that they may easily slide into position and compromise a substantial portion of the cavity of the housing compartment. In other embodiments, the temperature fillers may be moldable and/or flexible such that they may be inserted into any sized or shaped housing compartment.

In some embodiments, the temperature filler may be a cooling temperature filler. A cooling temperature filler may include ice or a freeze gel. In some embodiments, the freeze gel may include any one of a gelatin gel, an agar hydrogel, a polyvinyl alcohol gel, a carboxymethyl cellulose gel, or combinations thereof. In some embodiments, the temperature filler comprises a medical-grade ice pack. In some embodiments, the desired operating temperature of the sexual aid apparatus may be maintained at a temperature less than room temperature (approximately 35-65° F.). However, any suitable temperature may be used.

In some embodiments, the temperature filler may include a heating element, such as a heating rod, a heating coil or a heating foil. The heating element may include a heating carrier material, such as polyester, silicone rubber, polytetrafluoroethylene (PTFE), polyimide or other plastics. In some embodiments, the desired operating temperature of the sexual aid apparatus may be maintained at a temperature greater than room temperature (approximately 75-98° F.). However, any suitable temperature may be used.

The walls of the housing compartment may contain an insulating material. The insulating material may help to maintain the desired temperature. The insulating material may, additionally or alternatively, help to prevent the apparatus from becoming too cold or too hot. In insulating embodiments, a cooling element filler may be less 35-65° F. and/or a heating element filler may be more than 75-98° F. In some embodiments, one or more insulating layers may be used. In at least one embodiment, an interior insulating material/layer may be comprised of the same material as the exterior layer of the apparatus. In other embodiments, an internal insulating material/layer may be comprised of a different material as the exterior of layer of the apparatus. In at least one embodiment, the pocket for the filler may be surrounded by an interior layer comprised of stainless steel, which may be surrounded by an exterior layer of the apparatus comprised of silicon.

In some embodiments, a user may desire to place a warming temperature filler in a first housing compartment and a cooling temperature filler in a second housing compartment. This may allow the user to alternate between sensations.

In some embodiments, the head portion 110, end portion, 130, and shaft 120 may be fabricated as one continuous piece. In other embodiments, the head portion 110, end portion 130, and/or shaft 120 may be comprised of one or more connected pieces.

In some embodiments, the shaft 120, the head portion 110, the holder 140, or the end member 134 may be formed of one or more materials commonly used to form sexual aids. For example, the shaft 120, the head portion 110, the holder 140, or the end member 134 may be formed of inert and hypoallergenic material. In some embodiments, the shaft 120, the head portion 110, the holder 140, or the end member 134 may be formed of any one of: latex rubber, silicone, acrylic, glass, cyberskin, vinyl, metal, plastic, or combinations thereof. In some embodiments, the shaft, the head portion, the holder, and the end member are formed of different materials.

The sexual aid apparatus of the present invention can be provided in different sizes, different shapes, different colors, with and without vibrator(s), etc. In some embodiments, the sexual aid apparatus 100 further comprises a rabbit affixably attached to the outer surface of the end portion. The rabbit may be in the shape of two tiny fingers or bunny ears. “Rabbit” or “bunny,” as used herein, is known to be sexually prolific and refers to a sexual apparatus, designed to give a woman sexual pleasure by contacting and/or massaging her clitoris. In some embodiments, the sexual aid apparatus 100 further comprises a vibrating device located at the head portion or the shaft, wherein the vibrating device causes at least the head portion vibrates during use. The vibrating device increases sexual pleasure and to provide additional sensation for a user.

In some embodiments, the sexual aid apparatus 100 may include a power supply and a motor within the shaft 120 that enable the sexual aid apparatus 100 to vibrate. The motor may be controlled by a combination switch and a potentiometer, the potentiometer located at the proximal end of the longitudinal shaft. In some embodiments, the sexual aid apparatus 100 may include may further include electrical wiring that connects a potentiometer, a motor, and a power supply. The electrical wiring may be placed inside the shaft 120. In some embodiments, vibration of the sexual aid apparatus 100 may be powered by a battery. The battery may be located at the bottom of the sexual aid apparatus 100 as well as inside its mid-section.

Also within the scope of this disclosure is a kit comprising a sexual aid apparatus described above. The kit may also include instructions for use. For example, the instructions may inform the user of the proper procedure to use the disclosed sexual aid apparatus on a user.

In another aspect, this disclosure further provides a method of providing chilling or heating sensation in a bodily orifice (e.g., vagina, anus) of a user, e.g., for medical purposes or while providing sexual pleasure to the user. The method comprises loading a temperature filler (e.g., cold or heat pack) capable of providing a chilling or heating effect during use; and inserting the sexual aid apparatus as described into the bodily orifice of the user.

### Definitions

To aid in understanding the detailed description of the compositions and methods according to the disclosure, a few express definitions are provided to facilitate an unambiguous disclosure of the various aspects of the disclosure. Unless otherwise defined, all technical and scientific terms used herein have the same meaning as commonly understood by one of ordinary skill in the art to which this disclosure belongs.

The term “substantially,” as used herein, refers to the complete or nearly complete extent or degree of an action, characteristic, property, state, structure, item, or result.

It is noted here that, as used in this specification and the appended claims, the singular forms “a,” “an,” and “the” include plural reference unless the context clearly dictates otherwise.

The terms “including,” “comprising,” “containing,” or “having” and variations thereof are meant to encompass the items listed thereafter and equivalents thereof as well as additional subject matter unless otherwise noted.

The phrases “in one embodiment,” “in various embodiments,” “in some embodiments,” and the like are used repeatedly. Such phrases do not necessarily refer to the same embodiment, but they may unless the context dictates otherwise.

The terms “and/or” or “/” means any one of the items, any combination of the items, or all of the items with which this term is associated.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

As used herein, the term “each,” when used in reference to a collection of items, is intended to identify an individual item in the collection but does not necessarily refer to every item in the collection. Exceptions can occur if explicit disclosure or context clearly dictates otherwise.

The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All methods described herein are performed in any suitable order unless otherwise indicated herein or otherwise clearly contradicted by context. In regard to any of the methods provided, the steps of the method may occur simultaneously or sequentially. When the steps of the method occur sequentially, the steps may occur in any order, unless noted otherwise.

In cases in which a method comprises a combination of steps, each and every combination or sub-combination of the steps is encompassed within the scope of the disclosure, unless otherwise noted herein.

It is understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A sexual aid apparatus configured to provide a chilling or heating effect during use, comprising:
a hollow, longitudinal shaft comprising a housing compartment configured to contain a temperature filler;
a head portion located at a distal end of the shaft; and
an end portion located at a proximal end of the shaft,
wherein the end portion further comprises an opening configured to receive the temperature filler into the housing compartment and a cap member configured to seal the opening after the temperature filler is loaded in the housing compartment.

2. The sexual aid apparatus of claim 1, wherein the housing compartment further includes an insulated wall.

3. The sexual aid apparatus of claim 1, wherein the head portion is hollow and includes a second housing compartment.

4. The sexual aid apparatus of claim 1, further comprising a holder attached to the end portion.

5. The sexual aid apparatus of claim 1, further comprising a vibrating device configured to cause the apparatus to vibrate during use.

6. The sexual aid apparatus of claim 1, wherein the temperature filler comprises a freeze gel.

7. The sexual aid apparatus of claim 6, wherein the freeze gel comprises any one of a gelatin gel, an agar hydrogel, a polyvinyl alcohol gel, a carboxymethyl cellulose gel, or combinations thereof.

8. The sexual aid apparatus of claim 1, wherein the temperature filler comprises a medical-grade ice pack.

9. The sexual aid apparatus of claim 1, wherein the housing compartment is cylindrical in shape.

10. The sexual aid apparatus of claim 9, wherein the housing compartment is the same length as the shaft.

11. A sexual aid apparatus configured to assist in dilation, comprising:
a temperature filler;
a hollow shaft having an outer wall comprised of a hypoallergenic material and an inner wall defining a housing compartment;
an opening to the housing compartment;
a cap member configured to seal the opening; and
a head portion located at a distal end of the shaft;
wherein the temperature filler is contained within the housing compartment.

12. The sexual aid apparatus of claim 11, wherein the inner wall is comprised of an insulating material.

13. The sexual aid apparatus of claim 11, wherein the shaft and the head portion are fabricated as one piece.

14. The sexual aid apparatus of claim 11, wherein the shaft comprises a plurality of ridges.

15. The sexual aid apparatus of claim 11, wherein the apparatus contains a plurality of housing compartments each containing a temperature filler.

16. The sexual aid apparatus of claim 11, wherein the opening is located at a proximal end of the shaft.

17. The sexual aid apparatus of claim 11, wherein the opening is located at a distal end of the shaft.

18. The sexual aid apparatus of claim 17, wherein the head portion includes the cap member.

19. A method of providing a chilling or heating sensation in a bodily orifice of a user, comprising
receiving a sexual aid apparatus;
loading a temperature filler into a housing compartment located in a hollow shaft;
placing a cap member over an opening to the housing compartment thereby securing the temperature filler in the housing compartment; and
inserting a head portion, located at a distal end of the hollow shaft into a vaginal cavity.

20. The method of claim 19, wherein the temperature filler is cooling temperature filler.
